(19) United States
(12) Patent Application Publication
(10) Pub. No.: US 2015/0147712 A1
(43) Pub. Date: May 28, 2015

(54) AIR COOLED DENTAL PHOTOCURING LIGHT AND METHOD OF USING SAME

(71) Applicant: James L. Cannon, Murrayville, GA (US)

(72) Inventor: James L. Cannon, Murrayville, GA (US)

(21) Appl. No.: 14/091,953

(22) Filed: Nov. 27, 2013

(51) Int. Cl. A61C 13/15; A61C 1/00

(52) U.S. Cl. CPC A61C 19/004; A61C 1/0069
USPC 433/29; 433/215

(57) ABSTRACT

The invention comprises a dental tool. The dental tool comprises a hollow tool body having a light source disposed in one end thereof. The dental tool also comprises a hollow tube disposed within the hollow tool body, the hollow tube having a first end disposed adjacent the light source and an opposite second end connectable to a source of pressurized air. The dental tool further comprises at least one vent hole formed in the hollow tool body distal from the light source such that air emitted from the first end of the hollow tube absorbs heat from the light source and the heated air is discharged from the hollow tool body through the vent hole. A method of using the dental tool is also disclosed.

### FIELD OF THE INVENTION

The present invention generally relates to dental tools. More particularly, this invention relates to a dental tool for curing orthodontic adhesives. Specifically, the present invention relates to a dental tool including an air cooled light for curing photocurable adhesives. A method of using the dental tool is also disclosed.

### BACKGROUND OF THE INVENTION

In the practice of corrective orthodontia, orthodontic attachments are typically bonded to the labial surface of teeth and metal wires are attached to the attachments to exert forces on the attachments to slowly move the teeth into proper alignment. Examples of orthodontic brackets are shown in U.S. Pat. Nos. 5,512,838; 5,248,257 and 7,329,120 (the disclosures of which are all incorporated herein by reference). The bonding of orthodontic attachments to teeth has been in existence for at least 35 years. The bonding of orthodontic attachments to teeth is typically accomplished with a photocurable polymeric adhesive or an adhesive whose curing is accelerated or initiated by exposure to light, typically ultraviolet light. Such adhesives are also employed to in general dentistry to cure adhesives associated with fillings, crowns and the like.

A dental instrument including a curing light for example an ultraviolet light, such as a UV LED, is typically placed near or in a patient's mouth so that the UV light from the instrument can illuminate the adhesive to be cured or to initiate polymerization. Lights, such as UV lights, especially LED UV lights produce a considerable amount of heat. Therefore, prior art dental curing lights use a significant amount of insulation around the UV light. This increases the size of the instrument making it bulky and more difficult to fit into a patient's mouth. However, even with insulation, such prior art tools get uncomfortably warm with continuous operation.

It would therefore be desirable to provide an orthodontic or dental tool including a curing light, for example a UV light, especially a UV LED, that includes a cooling system for cooling the hot light. It would also be desirable to make such an orthodontic or dental tool cuing light that is relatively smaller and easier to handle.

### SUMMARY OF THE INVENTION

The present invention satisfies the foregoing needs by providing a dental tool for curing photocurable adhesives or polymers. The dental tool comprises a hollow tool body having a light source disposed in one end thereof. The dental tool also comprises a hollow tube disposed within the hollow tool body, the hollow tube having a first end disposed adjacent the light source and an opposite second end connectable to a source of pressurized air. The dental tool further comprises at least one vent hole formed in the hollow tool body distal from the light source such that air emitted from the first end of the hollow tube absorbs heat from the light source and the heated air is discharged from the hollow tool body through the vent hole.

In an alternate disclosed embodiment, the present invention comprises a method of curing photocurable adhesives or polymers. The method comprises applying a photocurable substance to a tooth of a patient and illuminating the photocurable substance with a light source disposed in one end of a hollow tool body. The method further comprises applying pressurized air to the hollow tool body adjacent the light source and venting the pressurized air heated by the light source through a vent in the hollow tool body distal to the light source.

Accordingly, it is an object of the present invention to provide an improved dental tool for curing photocurable substances, such as adhesives or polymers.

Another object of the present invention is to provide a system for cooling the light source in a dental tool for curing photocurable substances.

A further object of the present invention is to provide a dental tool for curing photocurable substances that is safer to use.

Another object of the present invention is to provide a dental tool for curing photocurable substances that is more comfortable to use.

These and other objects, features and advantages of the present invention will become apparent after a review of the following detailed description of the disclosed embodiments and the appended drawing and claims.

### BRIEF DESCRIPTION OF THE DRAWINGS

FIG. 1 is a perspective view of a disclosed embodiment of the dental tool of the present invention.

FIG. 2 is a side view of the dental tool shown in FIG. 1.

FIG. 3 is a top plan view of the dental tool shown in FIG. 1.

FIG. 4 is a bottom plan view of the dental tool shown in FIG. 1.

FIG. 5 is a rear end view of the dental tool shown in FIG. 1.

FIG. 6 is a front end view of the dental tool shown in FIG. 1.

FIG. 7 is a partial close up perspective view of the dental tool shown in FIG. 1 showing the tool holding an orthodontic bracket adjacent a tooth to which the orthodontic bracket is to be attach showing the tooth being dried with pressurized air from the dental tool.

FIG. 8 is a partial close up view of the dental tool shown in FIG. 1 showing the tool adjacent a tooth with an orthodontic bracket attached thereto showing the orthodontic bracket being exposed to light from the dental tool.

FIG. 9 is a bottom plan view of an alternate disclosed embodiment of the dental tool of the present invention.

FIG. 10 is a front view of the dental tool shown in FIG. 9.

FIG. 11 is a front view of an alternate disclosed embodiment of the dental tool of the present invention.

FIG. 12 is a side view of an alternate disclosed embodiment of the dental tool of the present invention.

FIG. 13 is a top plan view of the dental toll shown in FIG. 12.

FIG. 14 is a front view of the dental tool shown in FIG. 12.

FIG. 15 is a rear view of the dental tool shown in FIG. 12.

FIG. 16 is a side view of an alternate disclosed embodiment of a dental tool in accordance with the present invention.

FIG. 17 is a front view of the dental tool shown in FIG. 16.

FIG. 18 is a partial cross-sectional view taken along the line 18-18 of the dental too shown in FIG. 17.

### DETAILED DESCRIPTION OF THE DISCLOSED EMBODIMENTS

As used herein, the terms “cure”, “curing” and variations thereof as applied to the term “adhesive” includes both curing all or a portion of the adhesive and/or initiating the curing of the adhesive.

Applicant's U.S. Pat. No. 8,317,513 is incorporated herein by reference in its entirety.

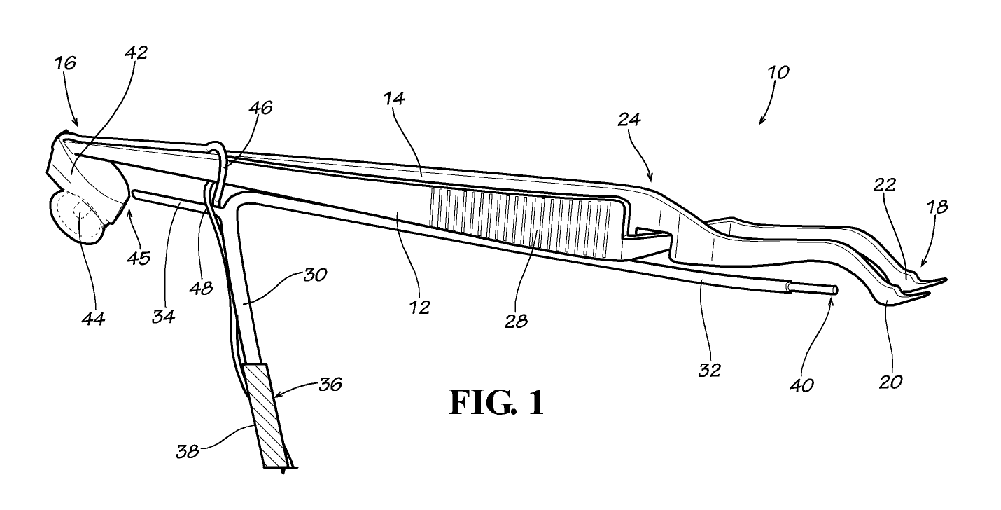

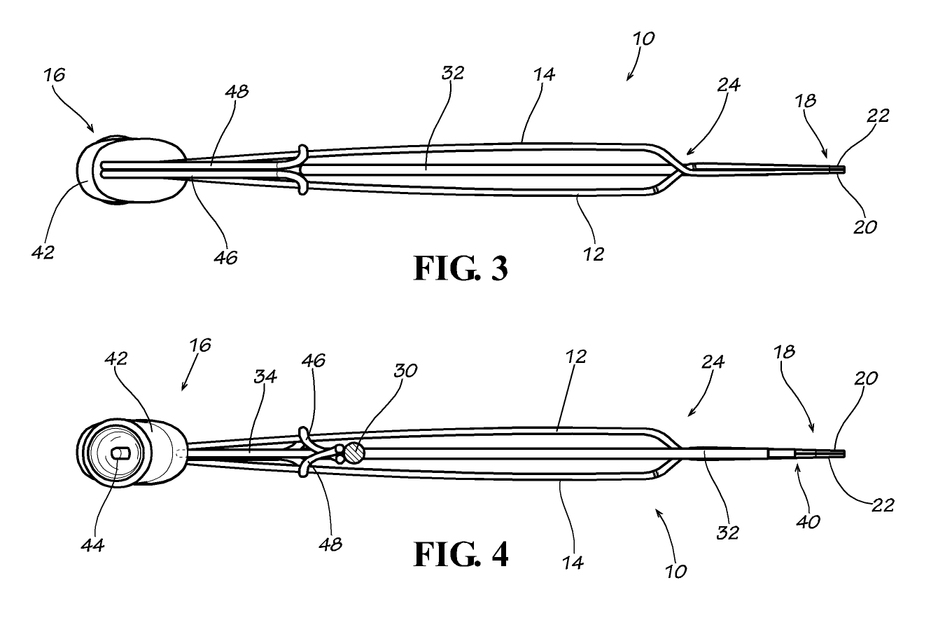

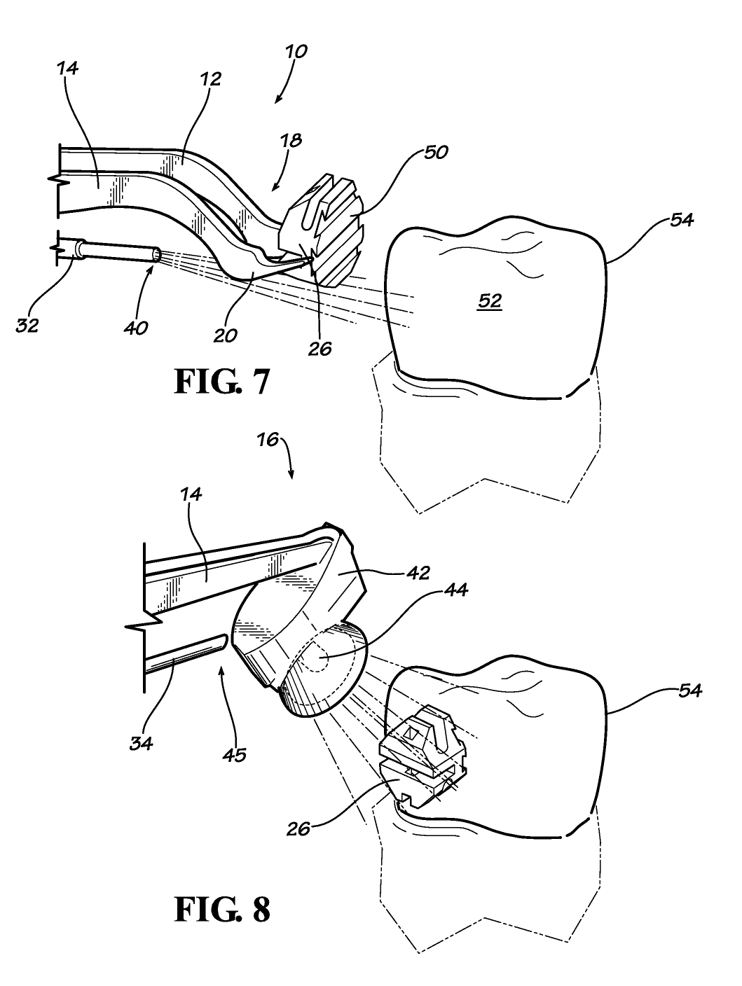

Referring now to the drawing in which like numbers indicate like elements throughout the several views, there is shown in FIG. 1 a disclosed embodiment of an orthodontic attachment bonding tool 10 in accordance with the present invention. Orthodontic attachments include, but are not limited to, orthodontic brackets, buccal tubes, cleats and eyelets. The orthodontic attachment bonding tool 10 comprises orthodontic attachment placement tweezers. In the embodiment shown in FIG. 1 the tweezers are reverse action tweezers; i.e., the tweezers are squeezed to open the jaws and released to close the jaws. Normal action tweezers can also be used; i.e., the tweezers are squeezed to close the jaws and released to open the jaws. Pliers can also be used, although tweezers are preferred. In fact, any tool that is capable of selectively gripping, or otherwise holding, an orthodontic attachment for placement on a tooth is suitable for use in the present invention. The orthodontic attachment bonding tool 10 comprises a pair of elongate stainless spring steel members 12, 14. The spring members 12, 14 are joined together at the rear end 16 of the tool 10, such as by welding. The front end 18 of the members 12, 14 form the jaws 20, 22 of the tool 10. Intermediate the front end 18 and the rear end 16 of the tool 10, the members 12, 14 are bent, such as at 24, so that the members cross over each other. From the bend 24 to the front end 18 of the tool 10, the members 12, 14 are of a reduced width and taper from the bend to the jaws 20, 22. The jaws 20, 22 are sized and shaped so that they are adapted to grip or hold an orthodontic bracket 26 (FIG. 7). The tool 10 can be operated by squeezing the members 12, 14 together, such as between a finger and thumb of an operator's hand placed on the knurled portion 28 of the members 12, 14, causing the jaws 20, 22 to move away from each other; i.e., open the jaws of the tweezers (FIG. 1 shows the jaws in the open position). Releasing the squeezing pressure on the members 12, 14 causes the jaws 20, 22 to move toward each other; i.e., close the jaws of the tweezers (FIGS. 3 and 4 show the jaws in the closed position). A tool of the configuration described above is typical of reverse action orthodontic attachment tweezers and tweezers as described above are commercially available under the designation Model No. 094-x from OrthoPli of Philadelphia, Pa.; Item #8019 and #8016 from Dental Corporation of America of West Chester, Pa.; and Article No. 3503 from Orthodontixx.com. Normal action tweezers are commercially available under the designation TDI-00-SA, from TDI International of Tucson, Ariz.

The tweezers described above are modified as follows to provide a tool 10 in accordance with the present invention. Attached to the bottom of the tool 10 is a small round hollow stainless steel tube 30. The tube 30 branches into a forwardly extending round hollow stainless steel tube 32 and a rearwardly extending round hollow stainless steel tube 34. Attached to the end 36 of the tube 30 is a flexible hose 38 made from rubber or a flexible polymer material. The other end (not shown) of the hose 38 is attached to a source of dry, pressurized air (not shown), which is typically available in an orthodontist's or dentist's office. The end 40 of the forwardly extending tube 32 terminates adjacent the jaws 20, 22 and is directed generally to the point where the jaws meet when in the closed position (FIG. 4). The end 40 of the forwardly extending tube 32 provides a nozzle for emitting dry, pressurized air therefrom.

Attached to the rear end 16 of the tool 10 is a light source 42. The light source 42 includes a bulb, fluorescent tube, or light-emitting diode (“LED”) 44 for emitting light for curing adhesives used for bonding orthodontic attachments to teeth, preferably ultraviolet light (“UV-light”). Wires 46, 48 connect the bulb, fluorescent tube or LED 44 to a source of electricity (not shown) suitable for energizing the bulb, fluorescent tube or LED such that it emits light of a suitable intensity and wavelength for curing adhesive used for bonding orthodontic attachments to teeth. The end 45 of the rearwardly extending round hollow stainless steel tube 34 terminates adjacent the light source 42 and is directed thereon. The end 45 of the rearwardly extending tube 34 provides a nozzle for emitting dry, pressurized air therefrom.

Use of the orthodontic attachment bonding tool 10 will now be considered. An orthodontic bracket 26 is grasped with the tool 10 by squeezing together the knurled portions 28 of the members 12, 14 thereby opening the jaws 20, 22, positioning the orthodontic bracket between the open jaws and allowing the jaws to close thereby capturing the orthodontic bracket between the jaws of the tool. A quantity of light-curable adhesive, preferably UV-curable adhesive, is the applied to the rear surface 50 of the orthodontic bracket 26 that will be applied to the labial surface 52 of a tooth 54 to which the orthodontic bracket is to be attached. Using a remote foot switch (not shown) to operate a valve (not shown) dry, pressurized air flows through the flexible tube 38, through the tube 30 and through both the forwardly extending tube 32 and the rearwardly extending tube 34. The dry, pressurized air then flows out of the end 40 of the forwardly extending tube 32 and also out of the end 45 of the rearwardly extending tube 34. The tool 10 holding the orthodontic bracket 26 between the jaws 20, 22 is positioned adjacent the tooth 54 (FIG. 7) such that dry, pressurized air flowing out of the end 40 of the forwardly extending tube 32 is directed onto the surface 52 of the tooth 54. No initial preparation or drying of the oral cavity is required prior to attaching an orthodontic attachment when practicing the present invention. The dry, pressurized air flowing from the end 40 of the tube 32 onto the surface 52 of the tooth 54 pushes saliva on the tooth's surface away from the position where the orthodontic bracket is to be attached and the remaining thin layer of saliva on the tooth's surface is dried by the flow of air flowing over it. After sufficient dry, pressurized air has been applied to the tooth 54 such that the surface 52 thereof is dry, the orthodontic bracket 26 is applied to the tooth such that the adhesive-bearing surface 50 of the orthodontic bracket contacts the surface of the tooth. Since the dry, pressurized air from the end 40 of the tube 32 flows onto the surface 52 of the tooth 54 as the bracket 26 is placed on the tooth; the surface of the tooth is maintained in a dry state as the orthodontic bracket is placed thereon. After the orthodontic bracket 26 is placed on the tooth, the jaws 20, 22 of the tool 10 are opened to release the orthodontic bracket therefrom. If necessary, the pointed tips of the jaws 20, 22 can then be used to scrape any excess adhesive from the periphery of the orthodontic bracket 26 and/or from the tooth 54. Again, since dry, pressurized air from the end 40 of the tube 32 continues to flow onto the surface 52 of the tooth 54 during this scraping operation, the tooth and orthodontic bracket 26 are maintained in a dry state.

The tool 10 is then turned around such that the rear end 16 of the tool, which includes the light source 42, is positioned adjacent the tooth 54 (FIG. 8). The bulb, fluorescent tube, or LED 44 is then energized, such as by activating a footswitch (not shown), so that light from the light source 42, preferably UV-light, shines on and illuminates the adhesive holding the orthodontic bracket 26 on the tooth 54. The light from the light source 42 is shown on the orthodontic bracket 26 for a time sufficient to cure the adhesive thereby bonding the orthodontic bracket to the tooth 54. While the light from the light source 42 illuminates the orthodontic bracket 26 and tooth 54, air flowing from the end 45 of the tube 34 cools the light source 42 so that it does not get too hot.

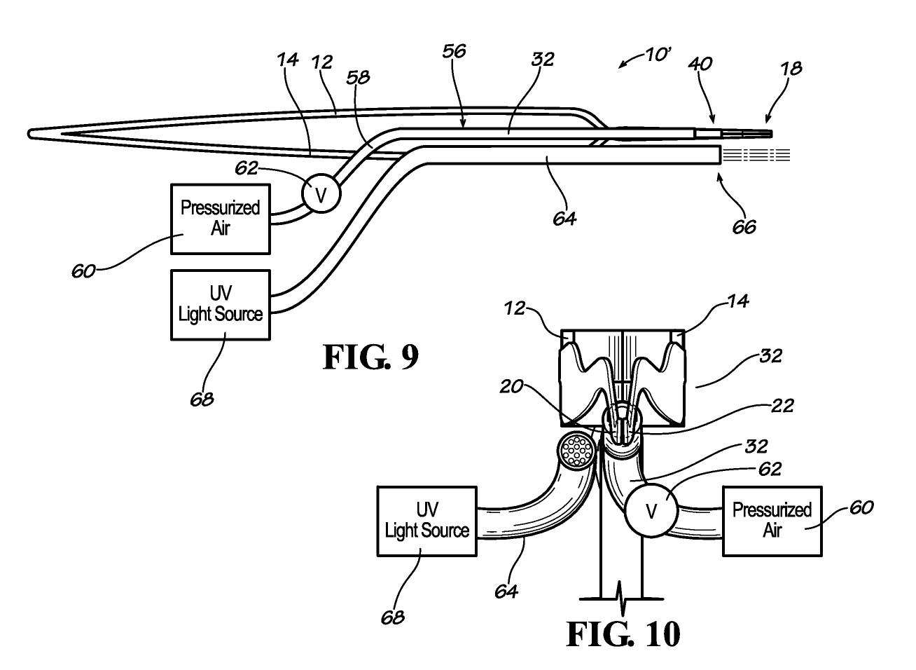

FIGS. 9 and 10 show an alternate disclosed embodiment of the orthodontic bonding tool 10′ of the present invention. In this embodiment, the same tweezers are used as described above and shown in FIG. 1. The same forwardly extending round hollow stainless steel tube 32 is used, however the end 56 of the tube 32 opposite the end 40 is connected to a flexible hose 58, which is connected to a source of dry, pressurized air 60. A valve 62 selectively connects the hose 58 and tube 32 to the source of pressurized air 60. Attached to the tweezers adjacent to the tube 32 is a fiber optical cable 64. The end 66 of the fiber optic cable 64 is adjacent the end 40 of the tube 32. The end of the fiber optic cable 64 opposite the end 66 is attached to a source of light 68, such as a bulb, fluorescent tube or LED (not shown) that emits visible light or UV-light. The source of light 68 is connected to a power source (not shown) sufficient for energizing the source of light. A switch (not shown) allows and operator to turn the source of light on and off. The fiber optic cable 64 is connected to the source of light 68 so that light from the source of light is conducted through the fiber optic cable and emitted from the end 66 thereof. Preferably, the source of light 68 is a source of UV-light and the fiber optic cable 64 will conduct UV-light. The source of light 68 is of an intensity and wavelength such that the light emitted from the end 66 of the fiber optic cable 64 is sufficient to cure adhesives used to attach orthodontic attachments to teeth.

Use of the orthodontic attachment bonding tool 10′ will now be considered. An orthodontic bracket 26 is grasped with the tool 10′ by opening the jaws 20, 22, positioning the orthodontic bracket between the open jaws and allowing the jaws to close thereby capturing the orthodontic bracket between the jaws of the tool. A quantity of light-curable adhesive, preferably UV-curable adhesive, is applied to the rear surface 50 of the orthodontic bracket 26 that will be applied to the labial surface 52 of a tooth 54 to which the orthodontic bracket is to be attached. Using a remote foot switch (not shown) to operate the valve 62 dry, pressurized air flows through the flexible tube 58 through the forwardly extending tube 32. The dry, pressurized air then flows out of the end 40 of the forwardly extending tube 32. The tool 10′ holding the orthodontic bracket 26 between the jaws 20, 22 is positioned adjacent the tooth 54 such that dry, pressurized air flowing out of the end 40 of the forwardly extending tube 32 is directed onto the surface 52 of the tooth 54. No initial preparation of the oral cavity is required when practicing this alternate disclosed embodiment of the present invention. The dry, pressurized air flowing from the end 40 of the tube 32 onto the surface 52 of the tooth 54 pushes saliva on the tooth's surface away from the position where the orthodontic bracket 26 is to be attached and the remaining thin layer of saliva on the tooth's surface is dried by the flow of air flowing over it. After sufficient dry, pressurized air has been applied to the tooth 54 such that the surface 52 thereof is dry, the orthodontic bracket 26 is applied to the tooth such that the adhesive-bearing surface 50 of the orthodontic bracket contacts the surface of the tooth. Since the dry, pressurized air from the end 40 of the tube 32 flows onto the surface 52 of the tooth 54 as the bracket 26 is placed on the tooth; the surface of the tooth is maintained in a dry state as the orthodontic bracket is placed thereon. After the orthodontic bracket 26 is placed on the tooth 54, the jaws 20, 22 of the tool 10 are opened to release the orthodontic bracket therefrom. If necessary, the pointed tips of the jaws 20, 22 can then be used to scrape any excess adhesive from the periphery of the orthodontic bracket 26 and/or from the tooth 52. Again, since dry, pressurized air from the end 40 of the tube 32 continues to flow onto the surface 52 of the tooth 54 during this scraping operation, the tooth and orthodontic bracket 26 are maintained in a dry state. The UV-light source 68 is then energized, such as by activating a footswitch (not shown), so that light from the light source 68 is emitted from the end 66 of the fiber optic cable 64 and shines on and illuminates the UV-curable adhesive holding the orthodontic bracket 26 on the tooth 54. Dry, pressurized air from the end 40 of the tube 32 continues to be directed onto the surface 52 of the tooth and orthodontic bracket 26 while the light from the end 66 of the fiber optic cable 64 illuminates the light-curable adhesive on the orthodontic bracket and tooth. The light from the fiber optic cable 66 is shown on the orthodontic bracket 26 for a time sufficient to cure the adhesive thereby bonding the orthodontic bracket to the tooth 54. While the light from the fiber optic cable 64 illuminates the orthodontic bracket 26 and tooth 54, air flowing from the end 40 of the tube 32 keeps the surface 52, adhesive and orthodontic bracket 26 dry thereby improving the bonding strength of the adhesive. In this embodiment, light and pressurized air can be emitted either simultaneously or alternately from the gripping end 18 of the tweezers.

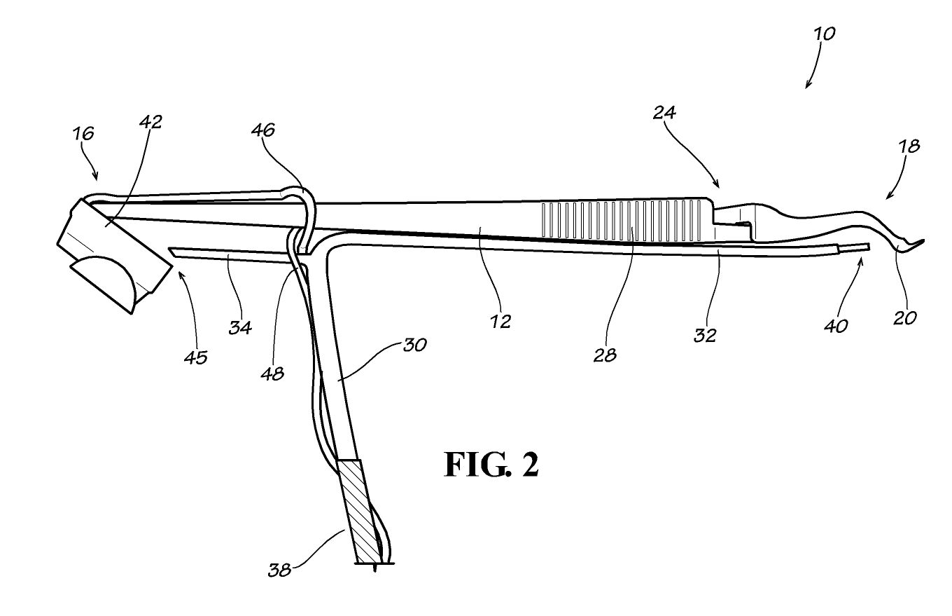

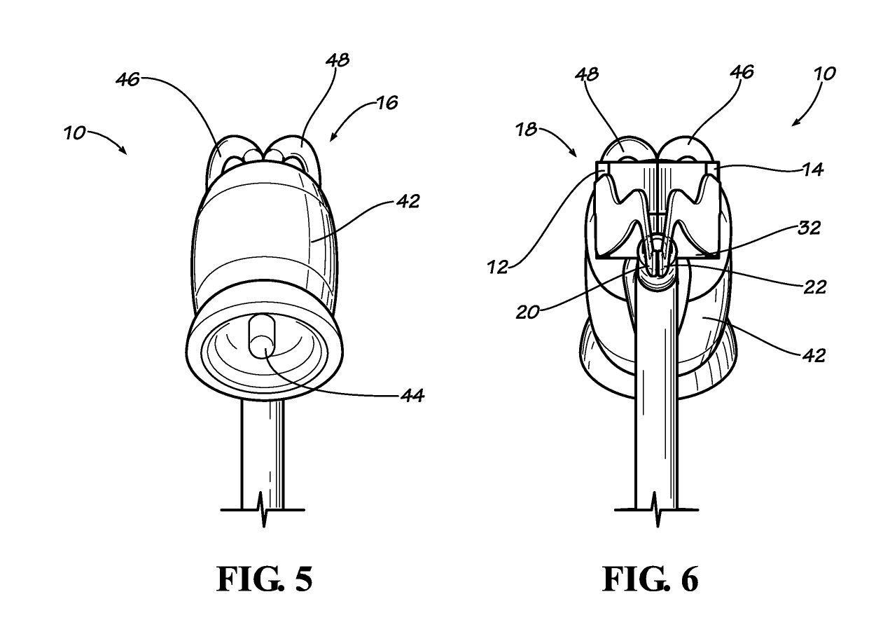

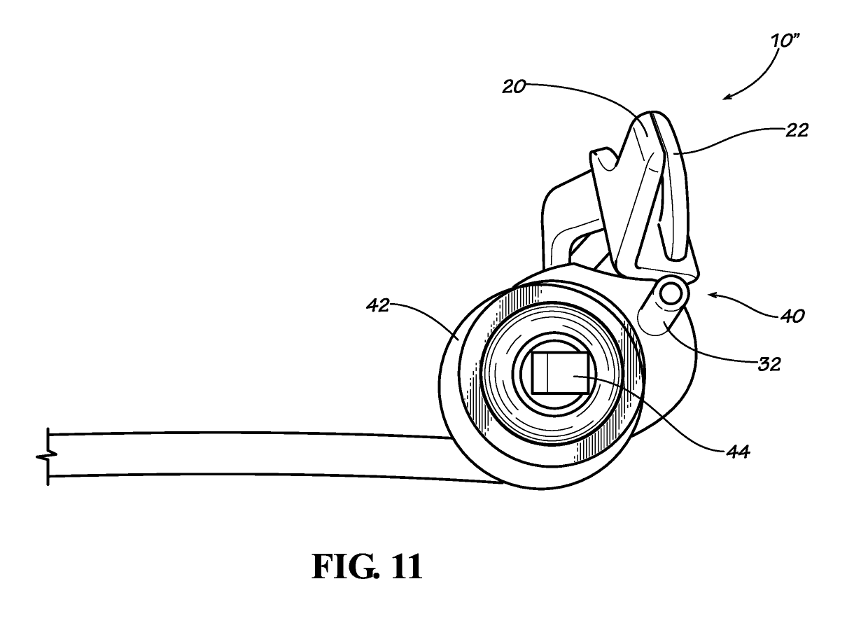

FIG. 11 shows an alternate disclosed embodiment of the orthodontic bonding tool 10″ of the present invention. In this embodiment, the same tweezers are used as described above and shown in FIG. 1. The difference between the embodiment shown in FIG. 11 and the embodiment shown in FIGS. 1-8 is that the light source 42 is moved from the rear end 16 of the tool 10″ to the front end 18 of the tool and the rearwardly extending tube 34 is not used. Therefore, in the embodiment shown in FIG. 11, the light source 42 is mounted to the tool 10″ adjacent the end 40 of the tube 32.

Use of the orthodontic attachment bonding tool 10″ will now be considered. An orthodontic bracket 26 is grasped with the tool 10″ by opening the jaws 20, 22, positioning the orthodontic bracket between the open jaws and allowing the jaws to close thereby capturing the orthodontic bracket between the jaws of the tool. A quantity of light-curable adhesive, preferably UV-curable adhesive, is the applied to the rear surface 50 of the orthodontic bracket 26 that will be applied to the labial surface 52 of a tooth 54. Using a remote foot switch (not shown) to operate a valve (not shown) dry, pressurized air flows through the flexible tube 38 and through the forwardly extending tube 32. The dry, pressurized air then flows out of the end 40 of the forwardly extending tube 32. The tool 10″ holding the orthodontic bracket 26 between the jaws 20, 22 is positioned adjacent the tooth 54 such that dry, pressurized air flowing out of the end 40 of the forwardly extending tube 32 is directed onto the surface 52 of the tooth 54. No initial preparation of the oral cavity is required when practicing this alternate disclosed embodiment of the present invention. The dry, pressurized air flowing from the end 40 of the tube 32 onto the surface 52 of the tooth 54 pushes saliva on the tooth away from the position where the orthodontic bracket 26 is to be attached and the remaining thin layer of saliva on the tooth's surface is dried by the flow of air flowing over it. After sufficient dry, pressurized air has been applied to the tooth 54 such that the surface 52 thereof is dry, the orthodontic bracket 26 is applied to the tooth such that the adhesive-bearing surface 50 of the orthodontic bracket contacts the surface of the tooth. Since the dry, pressurized air from the end 40 of the tube 32 flows onto the surface 52 of the tooth 54 as the orthodontic bracket 26 is placed on the tooth, the surface of the tooth is maintained in a dry state as the orthodontic bracket is placed thereon. After the orthodontic bracket 26 is placed on the tooth 54, the jaws 20, 22 of the tool 10″ are opened to release the orthodontic bracket therefrom. If necessary, the pointed tips of the jaws 20, 22 can then be used to scrape any excess adhesive from the periphery of the orthodontic bracket 26 and/or from the tooth 52. Again, since dry, pressurized air from the end 40 of the tube 32 continues to flow onto the surface 52 of the tooth 54 during this scraping operation, the tooth and orthodontic bracket 26 are maintained in a dry state. The end 18 of the tool 10″ is positioned adjacent the tooth 54. The UV-light LED 44 of the UV-light source 42 is then energized, such as by activating a footswitch (not shown), so that UV-light light from the LED shines on and illuminates the adhesive holding the orthodontic bracket 26 on the tooth 54. Dry, pressurized air from the end 40 of the tube 32 continues to be directed onto the surface 52 of the tooth and orthodontic bracket 26 while the light from the light source 42 illuminates the UV-curable adhesive on the orthodontic bracket and tooth. The light from the UV-light source 42 is shown on the orthodontic bracket 26 for a time sufficient to cure the adhesive thereby bonding the orthodontic bracket to the tooth 54. While the light from the UV-light source 42 illuminates the orthodontic bracket 26 and tooth 54, air flowing from the end 40 of the tube 32 keeps the surface 52, adhesive and orthodontic bracket 26 dry thereby improving the bonding strength of the adhesive. In this embodiment, light and pressurized air can be emitted either simultaneously or alternately from the gripping end 18 of the tweezers.

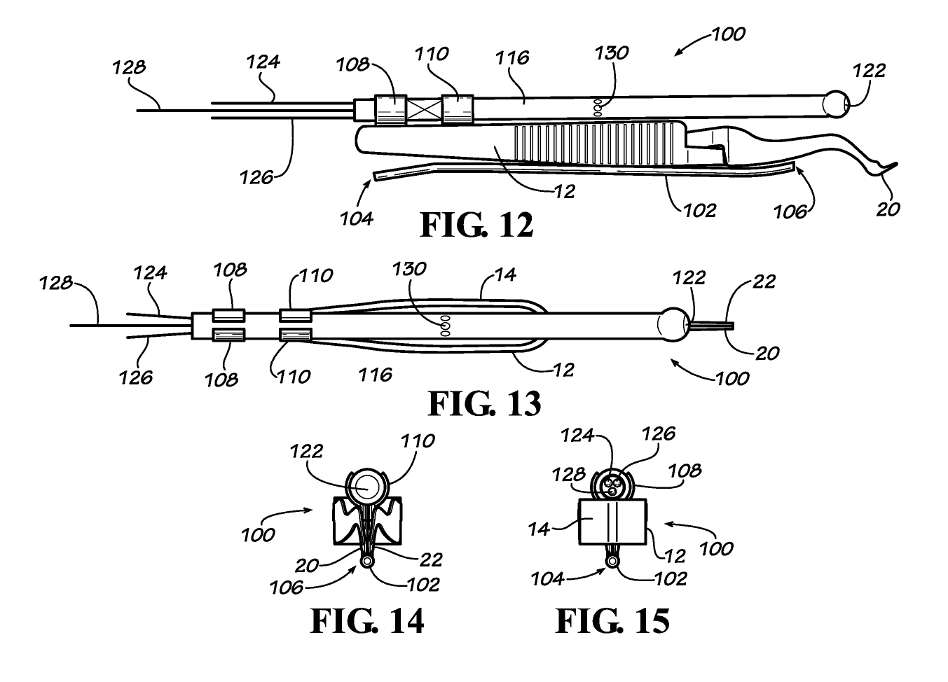

With reference to FIGS. 12-15, there is disclosed another alternate embodiment of the present invention. FIG. 12 shows an alternate disclosed embodiment of the orthodontic bonding tool 100 of the present invention. In this embodiment, the same tweezers are used as described above and shown in FIG. 1. Attached to the bottom of the tool 100 is a small, round, hollow, elongate, stainless steel tube 102. The tube 102 extends from the rear end 16 of the tool 100 to the front end 188 of the tool. The tube 102 is attached to the tweezers, such as by welding or soldering, the tube to the pair of elongate stainless spring steel members 12, 14 adjacent the rear end 16 of the tool 100. The rear end 104 of the tube 102 is bent slightly downwardly and away from the members 12, 14 so that a flexible hose (not shown) can be attached to the end of the tube. The flexible hose (not shown) can be attached to the end 104 of the tube 102 by any suitable coupling, such as by a bayonet-type coupling (not shown). The other end of the flexible hose (not shown) is attached to a source of dry, pressurized air. The front end 106 of the tube 102 terminates adjacent the jaws 20, 22 and is bent slightly upwardly and is directed generally to the point where the jaws meet when in the closed position. Thus, when dry, pressurized air is delivered to the end 104 of the tube 102, the pressurized air will travel through the tube and be expelled from the tube at the end 106 and the pressurized air will be directed generally to the point where the jaws 20, 22 meet when in the closed position.

Attached to the top of the tool 100, adjacent the rear end 16 thereof, are a pair of clips 108, 110. The clips 108, 110 are attached to the tweezers, such as by welding or soldering, the clips to the pair of elongate stainless spring steel members 12, 14 adjacent the rear end 16 of the tool 100. The clips 108, 110 are generally C-shaped and are made from spring steel. Each clips 108, 110 defines and upwardly facing opening 112, 114, respectively. The clips 108, 110 are designed so that a round tube, such as the tube 116, can be inserted into the clips through the openings 112, 114 and the clips will temporarily hold the tube in place on the tool 100. The clips 108, 110 are spaced from each other so as to provide more stability to the tube 116 when it is engaged in the clips. When desired, the tube 116 can be removed from the clips 108, 110 by pulling the tube away from the clips through the openings 112, 114. Thus, the clips 108, 100 provide a way for temporarily attaching the tube 116 to the tool 100 and removing the tube therefrom when desired.

The tube 116, when engaged in the clips 108, 100, extends from adjacent the rear end 16 of the tool 100 to adjacent the front end 18 of the tool. The tube 116 can be made from any rigid material, such as stainless steel or plastic. The portion of the tube 116 that fits between the clips 108, 100 can be of a slightly larger diameter or have bosses formed thereon so that when the tube is engaged in the clips, the tube cannot slide longitudinally forward or backward. The tube 116 is preferably round so that when the tube is engaged in the clips 108, 100, the tube can be rotate about its longitudinal axis by rotating the tube with one's fingers. The tube 116 is hollow. Mounted at the front end 120 of the tube 116 is a light emitting diode 122, which emits either visible light or UV-light. The light emitting diode 122 is connected to one end of a pair of electrical wires 124, 126, which extend from the light emitting diode, through the tube 116 and exit the tube at the rear end 128 thereof. The other end of the electrical wires 124, 128 are connected to a suitable power source and control box (not shown) that is located remote from the tool 100. The electrical wires 124, 126 are flexible so that even though they are connected to the remote power source (not shown), the tool 100 can be manipulated freely.

One end of a flexible hose 128 is positioned inside the tube 116 adjacent the light emitting diode 122 entering through the rear end 128 thereof. The rear end 128 of the tube 116 is sealed with, for example a polymeric material or polymeric glue so that an air tight seal is formed in the rear end of the tube around the electrical wires 124, 126 and the flexible hose 128. The other end of the flexible hose 128 is connected to a source of dry, pressurized air (not shown). The tube 116 has a plurality of vent holes 130 formed intermediate the opposite ends 120, 128 of the tube. The holes 130 are spaced circumferentially around the tube 116. Therefore, when pressurized air enters the tube 116 from the flexible hose 128 adjacent the light emitting diode 122. Air inside the tube 116 adjacent the light emitting diode 122 will be heated by the light emitting diode when it is lit. The heated air is then vented out of the tube 116 through the vent holes 130, thereby cooling the light emitting diode 122.

Use of the orthodontic attachment bonding tool 100 will now be considered. The tool 100 is assembled by first slipping a close fitting clear plastic sheath (not shown) over the end 120 of the tube 116. The plastic sheath is provided for sanitary reasons since autoclaving the light emitting diode 122 is not possible. The sheath will completely cover the light emitting diode 122 and a portion of the tube 166 up to, but not covering, the holes 130. The tube 116 is then attached to the tweezers by pressing the rear portion 128 of the tube into the clips 108, 110. The flexible hose 128 and the electrical wires 124, 126 are already connected to a control box, which selectively provides dry pressurized air to the hose 128, and electricity to the wires as desired by the operator. Another flexible hose (not shown) connected to the control box and source of dry, pressurized air (not shown) is connected to the rear end 104 of the tube 102.

An orthodontic bracket 26 is grasped with the tool 100 by squeezing together the knurled portions 28 of the members 12, 14 thereby opening the jaws 20, 22, positioning the orthodontic bracket between the open jaws and allowing the jaws to close thereby capturing the orthodontic bracket between the jaws of the tool. A quantity of light-curable adhesive, preferably UV-curable adhesive, is the applied to the rear surface 50 of the orthodontic bracket 26 that will be applied to the labial surface 52 of a tooth 54 to which the orthodontic bracket is to be attached. Using a remote foot switch (not shown) to operate a valve (not shown) dry, pressurized air flows through the flexible tube, through the tube 102 and out of the end 106. The tool 100 holding the orthodontic bracket 26 between the jaws 20, 22 is positioned adjacent the tooth 54 (FIG. 7) such that dry, pressurized air flowing out of the end 106 of the tube 102 is directed onto the surface 52 of the tooth 54. No initial preparation or drying of the oral cavity is required prior to attaching an orthodontic attachment when practicing the present invention. The dry, pressurized air flowing from the end 106 of the tube 102 onto the surface 52 of the tooth 54 pushes saliva on the tooth's surface away from the position where the orthodontic bracket is to be attached and the remaining thin layer of saliva on the tooth's surface is dried by the flow of air flowing over it. After sufficient dry, pressurized air has been applied to the tooth 54 such that the surface 52 thereof is dry, the orthodontic bracket 26 is applied to the tooth such that the adhesive-bearing surface 50 of the orthodontic bracket contacts the surface of the tooth. Since the dry, pressurized air from the end 106 of the tube 102 flows onto the surface 52 of the tooth 54 as the bracket 26 is placed on the tooth; the surface of the tooth is maintained in a dry state as the orthodontic bracket is placed thereon. After the orthodontic bracket 26 is placed on the tooth 54, the jaws 20, 22 of the tool 100 are opened to release the orthodontic bracket therefrom. If necessary, the pointed tips of the jaws 20, 22 can then be used to scrape any excess adhesive from the periphery of the orthodontic bracket 26 and/or from the tooth 54. Again, since dry, pressurized air from the end 106 of the tube 102 continues to flow onto the surface 52 of the tooth 54 during this scraping operation, the tooth and orthodontic bracket 26 are maintained in a dry state. Using another footswitch (not shown), the light emitting diode 122 is energized so that light from the light emitting diode, preferably UV-light, shines on and illuminates the adhesive holding the orthodontic bracket 26 on the tooth 54. At the same time that the light emitting diode is energized, pressurized air is delivered to the tube 116 through the flexible hose 128. This air cools the light emitting diode 122 while it is illuminated. The light from the light emitting diode 122 is shown on the orthodontic bracket 26 for a time sufficient to cure the adhesive thereby bonding the orthodontic bracket to the tooth 54. While the light from the light emitting diode 122 illuminates the orthodontic bracket 26 and tooth 54, air flowing from the end 106 of the tube 102 keeps the tooth and orthodontic bracket dry during the curing of the adhesive.

The control box (not shown) contains circuitry such that the light emitting diode 122 will be energized for a desired period of time, such as 10 seconds. If additional curing is necessary, the footswitch (not shown) can be pressed again thereby energizing the light emitting diode 122 for another 10 seconds. This procedure can be repeated as many times as necessary to cure the adhesive on the orthodontic bracket 26. The circuitry in the control box (not shown) will also keep the air flowing through the flexible tube 128 and tube 130 for a period of time, such as 10 seconds, after the light emitting diode 122 is no longer energized; i.e., after the light is turned off, so as to further cool the light emitting diode. Alternately, instead of a footswitch, a key pad can be used by a dental assistant to turn the sir flow and light emitting diode 122 on.

After the adhesive on the orthodontic bracket 26 is cured, the tube 166 is disconnected from the tweezers by pulling the tube out of the clips 108, 110. The plastic sheath on the end of the tube 120 is removed and discarded. The flexible hose (not shown) attached to the rear end 104 of the tube 102 is removed therefrom. The tweezers can then be placed in an autoclave for sterilization for future use.

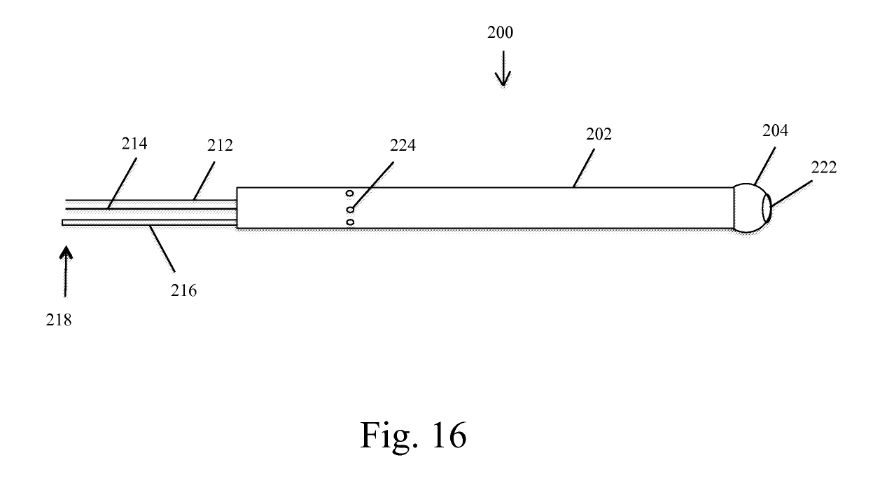

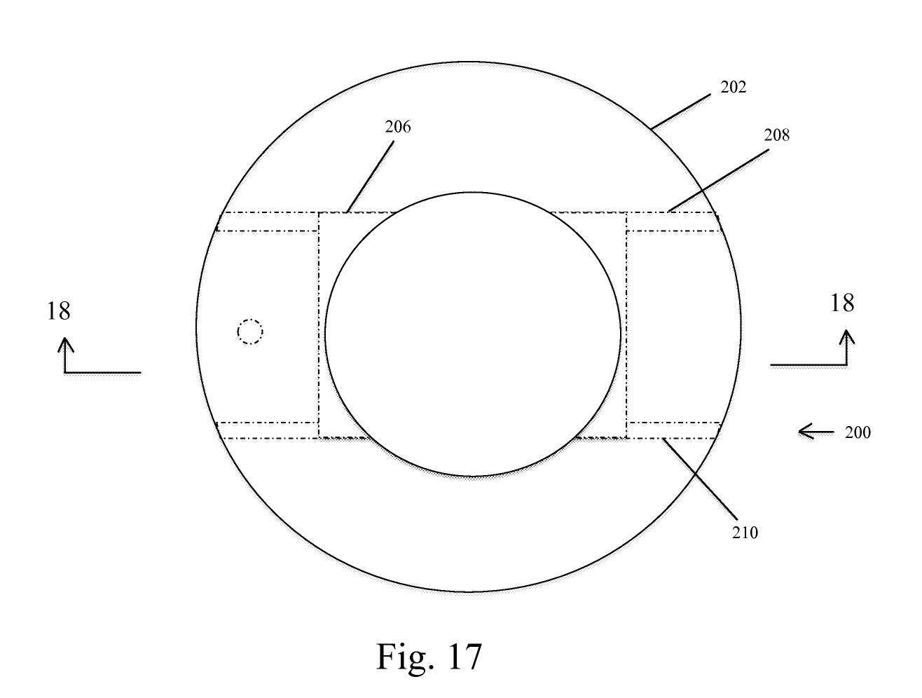

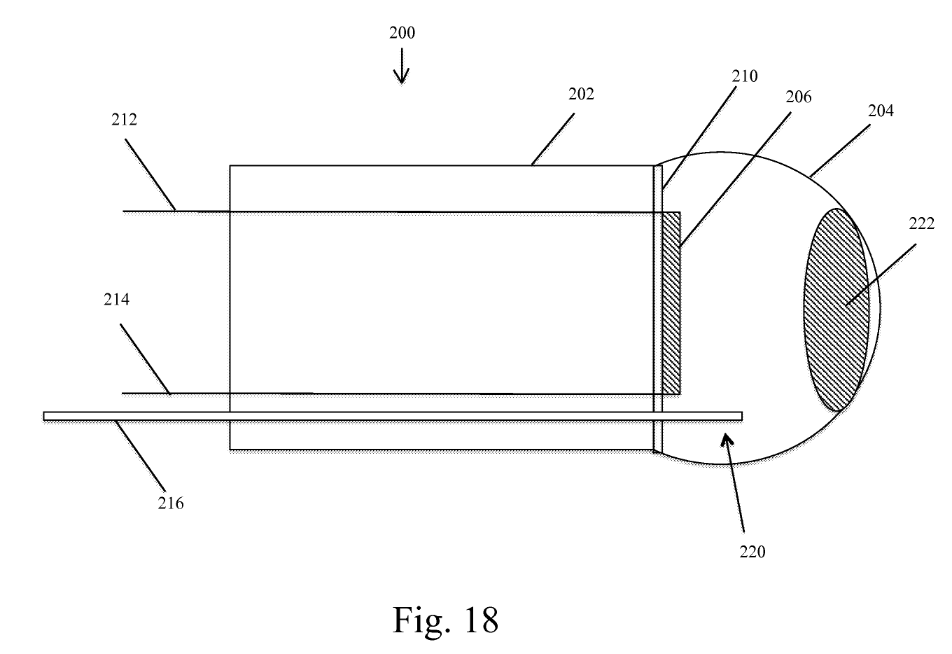

With reference to FIGS. 16-18 there is shown another disclosed embodiment of a dental tool 200 in accordance with the present invention. The dental tool 200 comprises a round, hollow, elongate, stainless steel tube member 202. A hollow, spherical, stainless steel enclosure 204 is attached to the tube member 202 at one end thereof. Disposed within the spherical enclosure 204 is an ultra violet light emitting diode 206. The light emitting diode 206 is supported by two rails 208, 210. The light emitting diode 206 is connected to a source of electricity (not shown) by a pair of electrically conductive wires 212, 214 disposed within the tube member 202. The electrical wires 212, 214 are preferably connected to a switch (not shown) for turning the light emitting diode 206 on and off. A hollow air supply tube 216 is disposed within the tube member 202 and extends from within the spherical enclosure 204 out of the opposite end of the tube member. The end 218 of the air supply tube 216 is connected to a source of dry, compressed air (not shown). The other end 220 of the air supply tube 216 is disposed within the spherical enclosure 204 adjacent the light emitting diode 206. Mounted in an opening in the spherical enclosure 204 is a lens 222. The lens 222 focuses the light from the light emitting diode 206. A plurality of vent holes 224 are formed in the tube member 202 adjacent the end of the tube member opposite the spherical enclosure 204. The vent holes 224 are spaced circumferentially around the tube member 202. The tube member 202 and the spherical enclosure 204 are in fluid communication with each other, so that compressed air introduced into the spherical enclosure by the end 220 of the air supply tube 216 flows from the spherical enclosure into the tube member and is exhausted out of the tube member through the vent holes 224. The end of the tube member 202 opposite the spherical enclosure 204 is sealed, for example with a polymeric material or polymeric glue, so that an air tight seal is formed in the rear end of the tube member around the electrical wires 212, 214 and the air supply tube 216.

Use of the dental tool 200 will now be considered. A photocurable adhesive or polymer is applied to the tooth of a patient, such as would be associated with an orthodontic dental appliance or a filling of a tooth. The end of the dental tool 200 having the lens 222 is placed adjacent or in the patient's mouth adjacent the photocurable adhesive or polymer. Electricity is supplied to the light emitting diode 206, such as by activating a foot switch, so that the light emitting diode emits light therefrom. The light from the light emitting diode 206 is focused by the lens 222 onto the photocurable adhesive or polymer so that the light illuminates the photocurable adhesive or polymer. Preferably, the same switch that that provides electricity to the light emitting diode 206 activates a solenoid operated valve (not shown) such that pressurized air is provided to the air supply tube 216 whenever the light emitting diode is turned on. The pressurized air travels through the air supply tube 216 and exits at the end 220. The air from the air supply tube 220 fills the spherical enclosure 204 and absorbs heat from the light emitting diode 206. The heated air is pushed out of the spherical enclosure 204 through the tube member 202 and out through the vent holes 224 adjacent the end of the tube member opposite the spherical enclosure. The volume of air provided by the air supply tube 216 removes sufficient heat from the light emitting diode 206 such that it does not reach a temperature that would burn the lips or gums of a patient if the spherical enclosure were to accidently touch the patient's lips or gums. This feature makes the dental tool 200 much more safe and comfortable to use than prior art dental light curing devices. The light from the light emitting diode 206 illuminates that adhesive or polymer for a time sufficient to cure or initiate polymerization of the photocurable adhesive or polymer. The switch (not shown) is then activated again so that the flow of electricity to the light emitting diode 206 and the compressed air to the air supply tube 220 are shut off.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A dental tool comprising:
a hollow tool body having a light source disposed in one end thereof;
a hollow tube disposed within the hollow tool body, the hollow tube having a first end disposed adjacent the light source and an opposite second end connectable to a source of pressurized air; and
at least one vent hole formed in the hollow tool body distal from the light source such that air emitted from the first end of the hollow tube absorbs heat from the light source and the heated air is discharged from the hollow tool body through the vent hole.

2. A method comprising:
applying a photocurable substance to a tooth of a patient;
illuminating the photocurable substance with a light source disposed in one end of a hollow tool body;
applying pressurized air to the hollow tool body adjacent the light source; and
venting the pressurized air heated by the light source through a vent in the hollow tool body distal to the light source.
